(19) United States
(12) Patent Application Publication
(10) Pub. No.: US 2022/0012647 A1
(43) Pub. Date: Jan. 13, 2022

(54) CHARGING STATION MANAGEMENT SERVER FOR CHARGING ELECTRIC VEHICLE AND RESERVATION METHOD THEREFOR

(71) Applicants: HYUNDAI MOTOR COMPANY, Seoul (KR); KIA MOTORS CORPORATION, Seoul (KR); RESEARCH & BUSINESS FOUNDATION SUNGKYUNKWAN UNIVERSITY, Suwon-si (KR)

(72) Inventors: So Jin Lee, Suwon-si (KR); Ji Hwon Kim, Gwangmyeong-si (KR); Tae-Jin Lee, Suwon-si (KR); Yunmin Kim, Suwon-si (KR); Kyoung Min Kim, Seoul (KR); Kwanyoung Moon, Daegu (KR)

(21) Appl. No.: 17/082,201

(22) Filed: Oct. 28, 2020

(30) Foreign Application Priority Data
Jul. 8, 2020 (KR) 10-2020-0084220

(51) Int. Cl. G06Q 10/02; G06Q 50/06; G06Q 10/06; G06Q 20/08; G06Q 30/00; G06Q 30/02; G07C 5/02; B60L 53/30; B60L 53/66; B60L 53/62

(52) U.S. Cl. CPC G06Q 10/02; G06Q 50/06; G06Q 10/06312; G06Q 20/085; G06Q 30/018; B60L 53/62; G06Q 10/06315; G07C 5/02; B60L 53/305; B60L 53/665; G06Q 30/0202

(57) ABSTRACT

A charging station management server and a reservation method thereof are provided. The charging station management server includes a communication device that communicates with an electric vehicle and a power grid management server and a processor that reserves a charging station based on driving information and information about the charging station, the driving information and the information being received from the electric vehicle, and information about a power supply state, the information being received from the power grid management server, when receiving a request to reserve the charging station from the electric vehicle.

### CROSS REFERENCE TO RELATED APPLICATIONS

This application claims the benefit of priority to Korean Patent Application No. 10-2020-0084220, filed in the Korean Intellectual Property Office on Jul. 8, 2020, the entire contents of which are incorporated herein by reference.

### TECHNICAL FIELD

The present disclosure relates to a charging station management server and a reservation method therefor, and more particularly, relates to technologies of allowing a vehicle to work with a charging station to automatically perform charging reservation and continuing power operation of the charging station.

### BACKGROUND

Recently, to address problems such as global warming due to carbon excessive emissions, there has been a growing interest in electric vehicles and hybrid vehicles and they have been developed to reduce carbon emissions.

In general, an electric vehicle (EV) refers to a car which uses its battery and motor without using petroleum-based fuels and an engine. Such an electric vehicle may operate using electrical energy charged in its battery as the battery loaded into the electric vehicle is charged by a general charging system in the parked state.

When it is necessary to charge the battery when the electric vehicle operates, a driver of the electric vehicle should visit a charging station to charge the battery. However, unlike a general car which uses oil as fuel, it takes a relatively long time for the electric vehicle to charge the battery.

Thus, while many electric vehicles are charging themselves or are waiting for charging in a specific charging station or when the supply and demand situation of power supplied to the charging station is degraded, an electric vehicle which visits the charging station may wait for a long time to charge its battery or it may be difficult for the electric vehicle to charge the electric vehicle as much as it wants.

### SUMMARY

The present disclosure has been made to solve the above-mentioned problems occurring in the prior art while advantages achieved by the prior art are maintained intact.

An aspect of the present disclosure provides a charging station management server for allowing an electric vehicle to reserve a charging station without consciousness of a driver of the electric vehicle to ensure operational continuity of the electric vehicle and change and cancel the reservation of the charging station with regard to a power supply situation of the charging station as well as a driving situation (e.g., a change in the destination, a change in the estimated time of arrival, or the like) and a reservation method therefor.

The technical problems to be solved by the inventive concept are not limited to the aforementioned problems, and any other technical problems not mentioned herein will be clearly understood from the following description by those skilled in the art to which the present disclosure pertains.

According to an aspect of the present disclosure, a charging station management server may include a communication device that communicates with an electric vehicle and a power grid management server and a processor that reserves a charging station based on driving information and information about the charging station, the driving information and the information being received from the electric vehicle, and information about a power supply state, the information being received from the power grid management server, when receiving a request to reserve the charging station from the electric vehicle.

In an embodiment, the driving information may include at least one of a destination, a vehicle path, a battery state, a charging type, an estimated time of arrival of the vehicle, or a necessary amount of power.

In an embodiment, the information about the charging station may include one of a location of the charging station, information about a current situation of charging station reservation, a supported charging type, or a charging time.

In an embodiment, the information about the current situation of charging station reservation may include at least one of an estimated time of arrival of each of vehicles reserved for each charging station, a charging time of each of the vehicles, or a necessary amount of power of each of the vehicles.

In an embodiment, the processor may automatically change or cancel the reservation of the charging station depending on one of a destination, a road environment, traffic volume, a vehicle path, a battery state, an estimated time of arrival, a charging type, information about the charging station, fee information, or a payment type.

In an embodiment, the processor may issue a certificate, when the reservation of the charging station is completed.

In an embodiment, the processor may receive advance reservation information from the electric vehicle and may transmit the advance reservation information to the reserved charging station, when the reservation of the charging station is completed.

In an embodiment, the processor may reserve a charging station, the amount of power demand of which is low, depending on the amount of power demand for each charging station predicted by the power grid management server.

In an embodiment, the processor may reserve the charging station using vehicle capacity and a charging fee for each charging station, the vehicle capacity and the charging fee being determined according to the power supply state.

According to another aspect of the present disclosure, a charging station management method may include receiving a request to reserve the charging station from an electric vehicle and reserving the charging station based on driving information of the electric vehicle, information about the charging station, and information about a power supply state.

In an embodiment, the method may further include periodically collecting information about the charging station from the charging station and the information about the power supply state from the power grid management server.

In an embodiment, the reserving of the charging station may include selecting a charging station terminal based on the driving information, the information about the charging station and the information about the power supply state, when the driving information is received from the electric vehicle and providing the electric vehicle with information about the selected charging station terminal.

In an embodiment, the method may further include automatically changing or canceling the reservation of the charging station depending on one of a destination, a road environment, traffic volume, a vehicle path, a battery state, an estimated time of arrival, a charging type, information about the charging station, fee information, or a payment type.

In an embodiment, the method may further include issuing a certificate for wireless charging, when the reservation of the charging station is completed.

In an embodiment, the method may further include receiving advance reservation information from the electric vehicle and transmitting the advance reservation information to the reserved charging station, when the reservation of the charging station is completed.

According to another aspect of the present disclosure, a charging station management method may include predicting the amount of power demand based on information about a current situation of charging station reservation, determining a power supply plan and a power fee based on the predicted amount of power demand, and providing a charging station with the power supply plan and the power fee.

In an embodiment, the predicting of the amount of power demand may include predicting at least one of the amount of power demand for each charging station, the amount of power demand for each area, or the amount of power demand for each time zone based on the information about the current situation of charging station reservation.

### BRIEF DESCRIPTION OF THE FIGURES

The above and other objects, features and advantages of the present disclosure will be more apparent from the following detailed description taken in conjunction with the accompanying drawings:

FIG. 1 is a drawing illustrating a configuration of a vehicle charging system according to an embodiment of the present disclosure;

FIG. 2 is a block diagram illustrating a detailed configuration of a charging station management server according to an embodiment of the present disclosure;

FIG. 3 is a signal sequence diagram illustrating a method for reserving a charging station in an electric vehicle and a process of charging an electric vehicle which arrives at a charging station according to an embodiment of the present disclosure;

FIGS. 4A and 4B are a signal sequence diagram illustrating in detail a method for reserving a charging station in an electric vehicle based on power information according to an embodiment of the present disclosure;

FIG. 5 is a drawing illustrating a process for reserving a charging station in an electric vehicle according to an embodiment of the present disclosure;

FIG. 6 is a drawing illustrating power supply flow for each power demand according to an embodiment of the present disclosure;

FIG. 7 is a drawing illustrating charging station reservation flow for each reservation time according to an embodiment of the present disclosure;

FIG. 8 is a drawing illustrating charging station management flow according to a change in the amount of power supply according to an embodiment of the present disclosure;

FIG. 9 is a drawing illustrating an example of a change in information about a current situation of charging station reservation according to an embodiment of the present disclosure; and

FIG. 10 is a block diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

An embodiment of the present disclosure may disclose technologies of automatically reserving a charging station for charging without recognition of a driver of an electric vehicle when there is a need for charging the electric vehicle while the electric vehicle is traveling, determining electric vehicle capacity and a fee of the charging station based on a power supply plan according to prediction of power demand to reserve the charging station to perform efficient operation of the charging station, such that the electric vehicle is automatically reserved in an optimal charging station to increase convenience of a user.

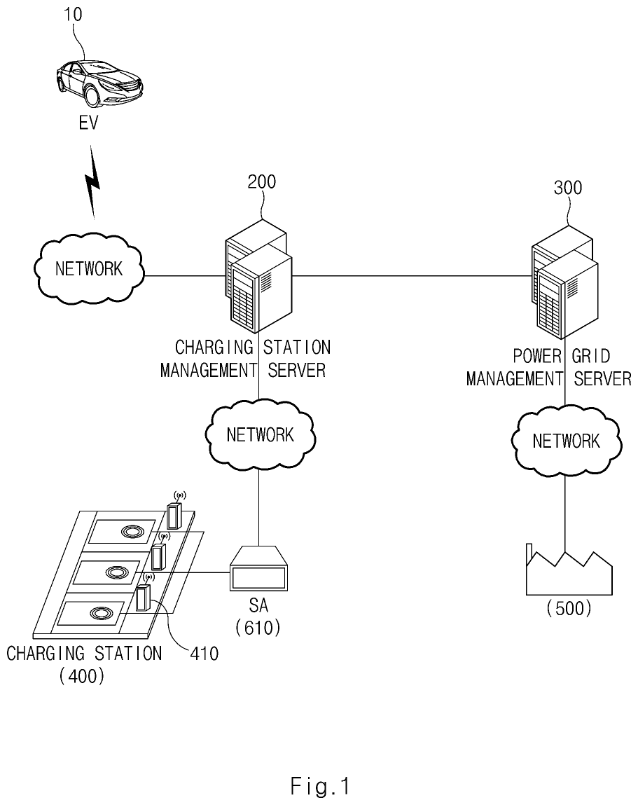

Hereinafter, embodiments of the present disclosure will be described in detail with reference to FIGS. 1 to 10.

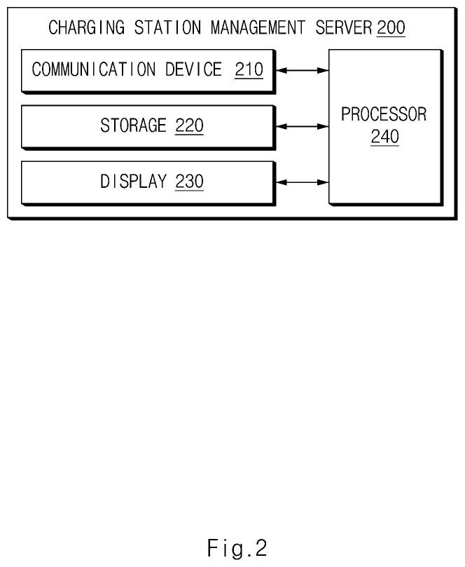

FIG. 1 is a drawing illustrating a configuration of a vehicle charging system according to an embodiment of the present disclosure. FIG. 2 is a block diagram illustrating a detailed configuration of a charging station management server according to an embodiment of the present disclosure.

Referring to FIG. 1, the vehicle charging system according to an embodiment of the present disclosure may include an electric vehicle 10, a charging station management server 200, and a power grid management server 300.

The electric vehicle 10 may be a vehicle traveling based on electric energy, which may communicate with the charging station management server 200 to monitor a power energy state of the electric vehicle 10 and reserve a charging station terminal 410 of a charging station 400 for operational continuity of the electric vehicle 10. In other words, when a power of the electric vehicle 10 for driving to a destination is insufficient, the electric vehicle 10 may automatically request the charging station management server 200 to reserve one of charging stations around the electric vehicle 10. In this case, when a destination is entered from a user, the electric vehicle 10 may calculate an amount of power necessary to the destination. When the amount of power necessary to the destination is greater than the current capacity of the battery of the electric vehicle 10 (when the power of the electric vehicle 10 is insufficient), the electric vehicle 10 may request to reserve a charging station.

The electric vehicle 10 may support an application for autonomous driving and navigation, may set a vehicle route and an estimated time of arrival using one of a destination, a road environment, or traffic volume, and may request to reserve a charging station.

The electric vehicle 10 may perform vehicle-to-everything (V2X) communication and vehicle-to-grid (V2G) communication with the charging station management server 200 and the power grid management server 300. In this case, the V2X communication is a technology of sharing information with a vehicle or a surrounding communication infrastructure for the purpose of providing a user with safety and convenience, which may define data transmission and reception for V2X communication in IEEE 802.11p and may define an application message for V2X communication in SAE J2735. Furthermore, the V2G communication is a technology of adjusting supply according to electric power demand through a connection of a power grid network with an electric vehicle or a charging station, which may define a communication protocol for managing a charging station which is one of energy storages on a power network in IEC 61850.

Furthermore, the electric vehicle 10 according to an embodiment of the present disclosure may perform wireless charging from the charging station terminal 410 of the charging station 400, may share information between the electric vehicle 10 and the charging station terminal 410 for wireless charging, and may be implemented based on a communication protocol for sharing a payment/charging type or the like for wireless charging of the electric vehicle 10 defined in ISO 15118.

The electric vehicle 10 may establish a session with the charging station terminal 410 in the charging station 400 to share information necessary for wireless charging and may share the information necessary for the wireless charging with the charging station terminal 410 through the established session. In this case, the information necessary for the wireless charging may include a battery state, a requested amount of charging, a time required for charging, a maximum voltage, a maximum current, a minimum current, or the like.

When the electric vehicle 10 arrives at the reserved charging station to charge the electric vehicle 10, the electric vehicle 10 may share information about a state of charge (SoC) with the charging station terminal 410 and may receive metering information from the charging station terminal 410. In this case, the metering information may include the amount of power and information about a usage fee.

The charging station management server 200 may be a server for managing charging stations for supply electric energy to the electric vehicle 10, which may communicate with the electric vehicle 10, the charging station terminal 410 of the charging station 400, and the power grid management server 300. The charging station management server 200 may be loaded into the electric vehicle 10 or may be a user terminal of a passenger who rides in the electric vehicle 10. When the charging station management server 200 is the user terminal of the passenger, it may communicate with the electric vehicle 10 to receive information about the electric vehicle 10.

When receiving a charging station reservation request from the electric vehicle 10, the charging station management server 200 may reserve a charging station based on driving information and information about the charging station, which are received from the electric vehicle 10.

In this case, the driving information may include at least one of a destination, a vehicle path, a battery state, a charging type, an estimated time of arrival of the vehicle, or a necessary amount of power. The information about the charging station may include at least one of a location of the charging station, information about a current situation of charging station reservation, a supported charging type, or a charging time, a billing type, a fee, or a power supply situation. Table 1 below is an example of storing the information about the charging station.

TABLE 1
DATABASE OF CHARGING STATION MANAGEMENT SERVER

| | CHARGING | CURRENT | REQUESTED | | |
|---|---|---|---|---|---|
| | STATION | SITUATION OF | AMOUNT OF | BILLING | |
| | TERMINAL | RESERVATION | CHARGING | TYPE | . . . |
| CHARGING | 1 | IN USE | WIRELESS | CARD | . . . |
| STATION A | 2 | RESERVATION AVAILABLE | WIRELESS | CARD | . . . |
| | 3 | RESERVATION AVAILABLE | WIRELESS | CARD | . . . |
| CHARGING | 1 | RESERVATION AVAILABLE | WIRELESS | CARD | . . . |
| STATION B | 2 | RESERVATION AVAILABLE | WIRELESS | CARD | . . . |
| | 3 | IN USE | WIRELESS | CARD | . . . |

CHARGING STATION INFORMATION

The information about the charging station like Table 1 above may include a current situation of reservation (reservation available or reservation unavailable) for each charging station terminal, a charging type (wireless or wired), or a billing type (a card or the like).

The charging station management server 200 may automatically change or cancel the reservation of the charging station depending on one of a destination, a road environment, traffic volume, a vehicle path, a battery station, an estimated time of arrival, a charging type, information about the charging station, fee information, or a payment type. In this case, the charging station management server 200 may automatically change or cancel the reservation of the charging station depending on a request of the electric vehicle 10.

When the reservation of the charging station is completed, the charging station management server 200 may issue a certificate and may transmit the certificate to the electric vehicle 10 and the charging station terminal 410 of the charging station 400 which is reserved, such that the electric vehicle 10 may perform fast charging based on the certificate when the electric vehicle 10 arrives at the charging station 400.

Furthermore, the charging station management server 200 may receive advance reservation information for charging in advance from the electric vehicle 10 when reserving the charging station 400 and may transmit the advance reservation information to the charging station terminal 410 of the charging station 400 which is reserved. In this case, the advance reservation information may be information necessary for the wireless charging, which may include a battery state, a requested amount of charging, a time required for charging, a maximum voltage, a maximum current, a minimum current, or the like. In other words, the charging station terminal 410 may receive advance reservation information in advance from the charging station management server 200 to prepare for charging in advance. Thus, because it is prepared to charge the electric vehicle 10 in advance when the electric vehicle 10 arrives at the reserved charging station 400, the electric vehicle 10 may immediately perform charging, thus reducing the time to prepare for charging.

The charging station terminal 410 may communicate with the power grid management server 300 to collect information about a power supply plan and a power fee in real time and determine electric vehicle capacity and a charging fee and may communicate with the charging station management server 200 to share the electric vehicle capacity and the charging fee.

The charging station 400 may be connected with a network via a gateway 610. The charging station 400 may access the network via the charging station terminal 410 to transmit and receive information necessary for charging. In other words, when receiving a charging information request, a charging station reservation request, and the like from the electric vehicle 10, the charging station terminal 410 may reserve a charging station and may then provide the electric vehicle 10 with charging reservation information. In this case, the charging reservation information provided to the electric vehicle 10 may include information (e.g., a location, fee information, or the like) of the reserved charging station.

The power grid management server 300 may manage the amount of power to distribute and supply power supplied from a power plant 500 to areas (cities), charging stations, or the like, may communicate with the charging station management server 200 to collect information about a current situation of charging station reservation in real time, and may predict the amount of power demand for each charging station, each area, or each time zone based on the information about the current situation of charging station reservation to determine a power supply plan and a power fee based on the amount of power demand.

FIG. 1 discloses an example where the charging station management server 200 and the power grid management server 300 are separately implemented, but not limited thereto. The charging station management server 200 and the power grid management server 300 may be implemented to be integrated into one server.

As such, the vehicle charging system according to an embodiment of the present disclosure may minimize a time taken to charge the electric vehicle by allowing the electric vehicle to identify a power state of the electric vehicle, automatically reserve a charging station through V2X communication without recognition of the user, and provide the charging station with advance reservation information.

Furthermore, the vehicle charging system according to an embodiment of the present disclosure may more efficiently reserve and manage charging stations by allowing the electric vehicle to reserve a charging station depending to a situation where power supplied to the charging stations is supplied and demanded.

Referring to FIG. 2, the charging station management server 200 may include a communication device 210, a storage 220, a display 230, and a processor 240.

The communication device 210 may be a hardware device implemented with various electronic circuits to transmit and receive a signal through a wireless or wired connection. As an example, the communication device 210 may perform V2X communication, V2G communication, wireless charging communication, or the like with the electric vehicle 10, the power grid management server 300, the charging station terminal 410, or the like. Furthermore, the communication device 210 may receive information about a power supply plan and a power fee from the power grid management server 300, may receive information about electric vehicle capacity and a charging fee from the charging station terminal 410, may receive a charging reservation request, advance reservation information, or the like from the electric vehicle 10, and may transmit charging reservation complete information to the electric vehicle 10.

As an example, the storage 220 may store the information about the power supply plan and the power fee, which is received from the power grid management server 300 outside the electric vehicle 10, or may store the information about the electric vehicle capacity and the charging fee, which is received from the charging station terminal 410. Furthermore, the storage 220 may store the advance reservation information received from the electric vehicle 10. The storage 220 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The display 230 may display information about a current situation of reservation of charging stations, information about a power supply plan and a power fee for each charging station, which is received from the power grid management server 300, or information about a charging station reservation request and a reservation change request of the electric vehicle 10. The display 230 may be implemented as a head-up display (HUD), a cluster, an audio video navigation (AVN), or the like. Furthermore, the display 230 may include one of a liquid crystal display (LCD), a thin film transistor-LCD (TFT-LCD), a light emitting diode (LED) display, an organic LED (OLED) display, an active matrix OLED (AMOLED) display, a flexible display, a bended display, or a three-dimensional (3D) display. Some thereof may be implemented as transparent displays configured as a transparent type or a semi-transparent type to see the outside. Moreover, the display 230 may be implemented as a touchscreen including a touch panel to be used as an input device other than an output device.

The processor 240 may be electrically connected with the communication device 210, the storage 220, the display 230, or the like and may electrically control the respective components. The processor 240 may be an electrical circuit which executes instructions of software and may perform a variety of data processing and calculation described below.

When receiving a request to reserve a charging station from the electric vehicle 10, the processor 240 may automatically reserve the charging station based on driving information and information about the charging station, which are received from the electric vehicle 10, and information about a power supply state, which is received from the power grid management server 300.

The processor 240 may automatically reserve a charging station using one of a destination, a vehicle path, a battery state, a charging type, an estimated time of arrival of the vehicle, or a necessary amount of power, which is received from the electric vehicle 10.

The processor 240 may automatically reserve a charging station using one of a location of the charging station, information about a current situation of charging station reservation, a supported charging type, or a charging time, which is collected by the charging station terminal 410.

When receiving a request to reserve a charging station from the electric vehicle 10, the processor 240 may reserve a charging station, the amount of power demand of which is low or the amount of power supply of which is high, depending on the amount of power demand for each charging station, which is predicted by the power grid management server 300.

Furthermore, the processor 240 may select an optimal charging station using vehicle capacity and a charging fee for each charging station, which are determined according to a power supply state, and may reserve the selected charging station.

When the reservation of the charging station is completed, the processor 240 may issue a certificate to verify the reservation and may transmit the certificate to a charging station terminal of the charging station, the reservation of which is completed, and the electric vehicle 10.

Furthermore, when the reservation of the charging station is completed, the processor 240 may provide the advance reservation information received from the electric vehicle 10 to a charging station terminal of the charging station. Thus, the charging station terminal may prepare for charging in advance and may quickly charge the electric vehicle 10 when the electric vehicle 10 arrives at the charging station terminal.

The processor 240 may automatically change or cancel the reservation of the charging station depending on one of a destination, a road environment, traffic volume, a vehicle path, a battery state, an estimated time of arrival, a charging type, information about the charging station, fee information, or a payment type. In other words, the processor 240 may communicate with the electric vehicle 10 on a real-time basis or on a periodic basis to identify a change in the destination, a change in the estimated time of arrival, a change in the road environment, a change in the traffic volume, a change in the vehicle path, a change in the battery state, a change in the charging type, a change in the payment type, or the like and may change the reserved charging station to another charging station or may cancel the reservation. Furthermore, the processor 240 may change or cancel the reservation of the charging station depending on a change in charging station situation (e.g., an increase in charging station customer, a failure in charging station terminal, or the like) through real-time or periodic communication with the charging station terminal.

The processor 240 may receive information about a power supply plan and a power fee for each charging station from the power grid management server 300 and may receive information about electric vehicle capacity and a charging fee from the charging station terminal, thus reserving an optimal charging station.

When a destination is entered before the electric vehicle 10 starts or when power to the destination is insufficient while the electric vehicle 10 is traveling, the electric vehicle 10 may request the charging station management server 200 to reserve a charging station for operational continuity. When the reservation of the optimal charging station is completed by the charging station management server 200 and the power grid management server 300, the electric vehicle 10 may arrive at the reserved charging station to quickly perform wireless charging.

Furthermore, an embodiment of the present disclosure may change or cancel the reservation of the charging station depending on a change in situation such as a change in the destination or a change in the estimated time of arrival to respond to the change in situation, thus flexibly responding to various situation changes capable of occurring in the driving process.

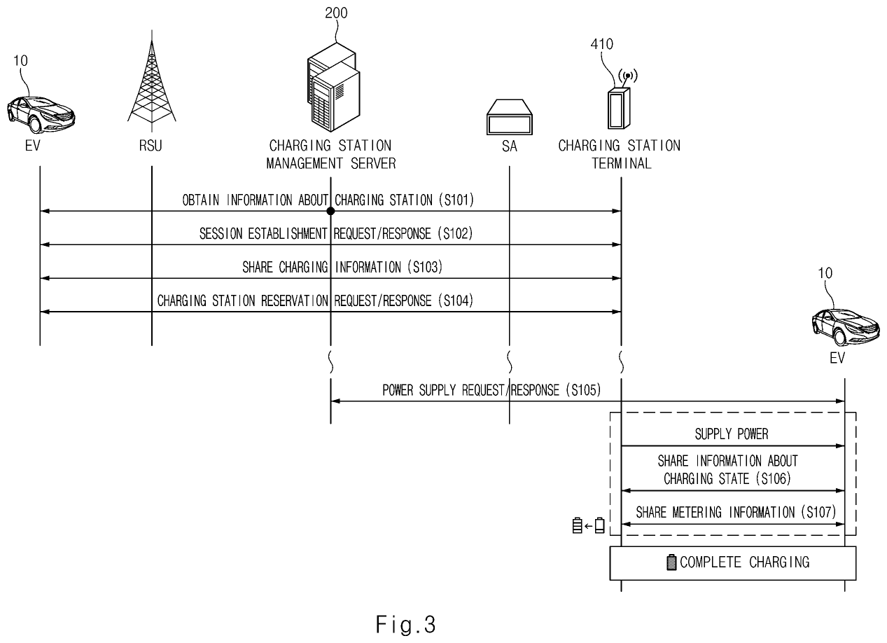

Hereinafter, a description will be given of a method for reserving a charging station in an electric vehicle according to an embodiment of the present disclosure with reference to FIG. 3. FIG. 3 is a signal sequence diagram illustrating a method for reserving a charging station in an electric vehicle according to an embodiment of the present disclosure.

Hereinafter, it may be assumed that an operation described as being performed by an electric vehicle 10 of FIG. 1 is performed by a charging station management server 200 loaded into the electric vehicle 10. Furthermore, an operation described as being performed by the electric vehicle 10 may be understood as being controlled by a processor 240 of the charging station management server 200.

Referring to FIG. 3, in S101, the charging station management server 200 may periodically communicate with a charging station terminal 410 to collect and manage information about a charging station and may transmit the information about the charging station, such as a location of the charging station, an ID of the charging station, a charging type, fee information, a payment type, a location of a charging station terminal, an ID of the charging station terminal, or information about a current situation of charging station reservation, to the electric vehicle 10.

In S102, the electric vehicle 10 may request a charging station terminal 410 to establish a session to share information necessary for wireless charging with the charging station terminal 410 and the charging station 410 may respond to the request by issuing a session ID.

In S103, the electric vehicle 10 may share charging information necessary for wireless charging, for example, a battery state, a requested amount of charging, a time taken for charging, a maximum voltage, a maximum current, or a minimum current, with the charging station terminal 410 and may request a charging station 400 to reserve charging based on the charging information. Thus, in S104, the charging station terminal 410 may respond to grant the reservation. In this case, when a destination is entered from a user, the electric vehicle 10 may calculate an amount of power necessary to the destination. When the amount of power necessary to the destination is greater than the current capacity of the battery of the electric vehicle 10 (when a power of the electric vehicle 10 is insufficient), the electric vehicle 10 may request to reserve a charging station and a shared vehicle.

Thereafter, in S105, the electric vehicle 10 may arrive at the charging station 400 and may request the charging station terminal 410 to supply power based on the reserved information and the charging station terminal 410 may identify the reservation of the electric vehicle 10 to notify the electric vehicle 10 of preparation for supplying power.

In S106, the electric vehicle 10 may receive as much power as it needs to be suitable for its characteristic through information necessary for wireless charging, which is previously exchanged, and may share charging state information with the charging station terminal 410. Thereafter, in S107, the charging station terminal 410 may share the supplied amount of power and metering information including fee information with the electric vehicle 10.

As such, when a vehicle power for driving to a destination is insufficient, the electric vehicle 10 according to an embodiment of the present disclosure may automatically request the charging station management server 200 to reserve a charging station and a shared vehicle. When receiving the request to reserve the charging station from the electric vehicle 10, the charging station management server 200 may reserve the charging station based on information about driving of the electric vehicle 10 and the information about the charging station.

Receiving the request to reserve the charging station, the charging station management server 200 may periodically collect information about a charging station, may select an optimal charging station terminal based on the driving information, which is received together with the request to reserve the charging station from the electric vehicle 10, and the information about the charging station, and may provide the electric vehicle 10 with information about the selected charging station terminal. Thus, the electric vehicle 10 may guide the route to the reserved (selected) charging station or may perform automatic driving control. To this end, the electric vehicle 10 may further include a navigation device (not shown) or an automatic driving controller (not shown).

Furthermore, the charging station management server 200 may automatically change or cancel the reservation of the charging station depending on at least one of a destination, a vehicle path, a road environment, traffic volume, an estimated time of arrival, a battery state, a charging type, information about the charging station, fee information, or a payment type or may automatically change or cancel the reservation of the charging station depending on a request of the electric vehicle 10. In other words, the electric vehicle 10 may request the charging station management server 200 to automatically change or cancel the reservation of the charging station depending on one of a destination, a vehicle path, a road environment, traffic volume, an estimated time of arrival, a battery state, a charging type, information about the charging station, fee information, or a payment type.

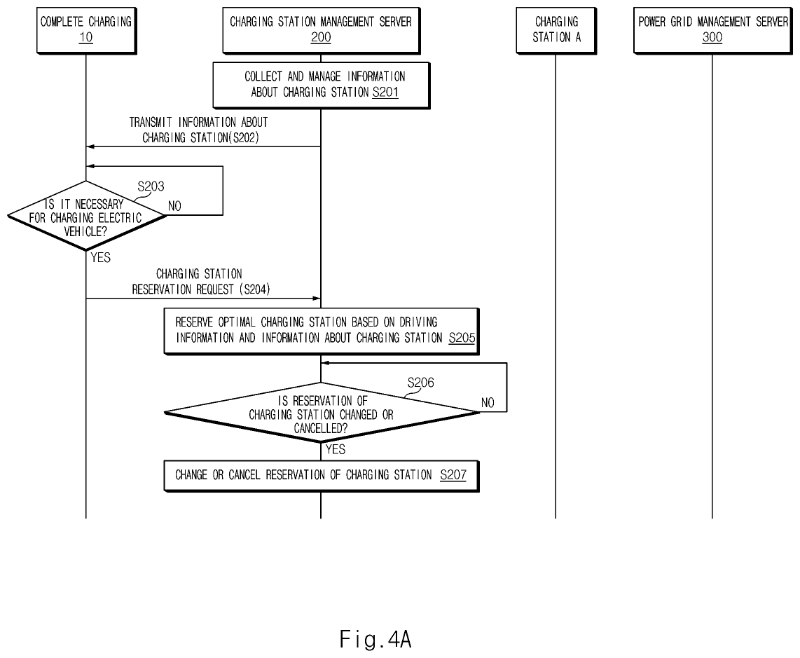

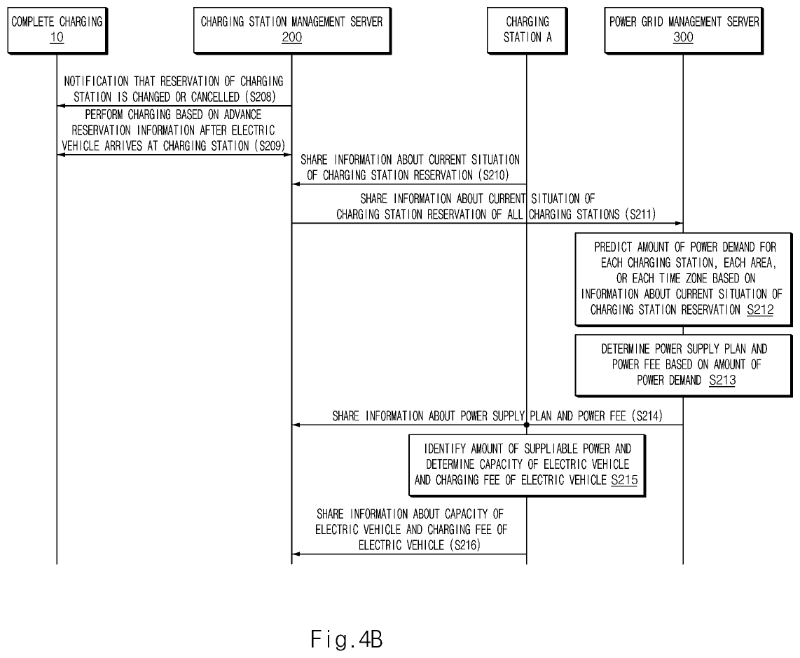

Hereinafter, a description will be given in detail of a method for reserving a charging station in an electric vehicle based on power information according to an embodiment of the present disclosure with reference to FIGS. 4A and 4B. FIGS. 4A and 4B are a signal sequence diagram illustrating in detail a method for reserving a charging station in an electric vehicle based on power information according to an embodiment of the present disclosure.

Hereinafter, it may be assumed that an operation described as being performed by an electric vehicle 10 of FIG. 1 is performed by a processor (not shown) loaded into the electric vehicle 10. Furthermore, an operation described as being performed by a charging station management server 200 may be understood as being controlled by a processor 240 of the charging station management server 200.

Referring to FIGS. 4A and 4B, in S201, the charging station management server 200 may collect and manage information about a charging station in real time. The information about the charging station may include at least one of information about a location of the charging station, information about a current situation of charging station reservation, information about a supported charging type, information about a billing type, fee information, or information about a power supply situation. Furthermore, the information about the current situation of charging station reservation may include information, for example, an estimated time of arrival of an electric vehicle 10, a charging time, or a necessary amount of power.

In S202, the charging station management server 200 may provide the electric vehicle 10 with the information about the charging station.

In S203, the electric vehicle 10 may determine whether a current power state of the electric vehicle 10 is a state which needs charging based on driving information and the information about the charging station. In other words, the electric vehicle 10 may compare a state of charge (SOC) predicted to be taken to arrive at a destination with a currently remaining SOC to determine whether it is necessary for charging the electric vehicle 10. In this case, the driving information may include at least one of a destination, a vehicle path, a battery state, a charging type, an estimated time of arrival of the electric vehicle 10, or a necessary amount of power. Furthermore, the information about the charging station may include at least one of information about a location of the charging station, information about a current situation of reservation, information about a supported charging type, information about a billing type, fee information, or information about a power supply situation.

When it is determined that it is necessary for charging the electric vehicle 10, in S204, the electric vehicle 10 may request the charging station management server 200 to reserve a charging station. In S205, the charging station management server 200 may reserve an optimal charging station with regard to a current situation of charging station reservation, a vehicle path received from the electric vehicle 10, or a power supply state and a fee received from the power grid management server 300, or the like. In this case, the electric vehicle 10 may transmit information about a current situation of advance reservation to the charging station management server 200 in advance to charge the electric vehicle 10 using the information about the current situation of advance reservation transmitted in advance when the electric vehicle 10 arrives at the charging station later to start to charge the electric vehicle 10, thus minimizing a preparation time for charging.

Meanwhile, in S206, the charging station management server 200 may determine whether it is necessary for changing or canceling the reservation of the charging station depending on a change in the destination, a change in the estimated time of arrival, a change in the charging station power supply situation, a change in the road environment, a change in the traffic volume, or the like. When it is necessary for changing or canceling the reservation of the charging station, in S207, the charging station management server 200 may change or cancel the reservation of the charging station. In S208, the charging station management server 200 may transmit information associated with changing or canceling the reservation of the charging station to the electric vehicle 10, such that the electric vehicle 10 knows to change or cancel the reservation of the charging station.

The charging station management server 200 may receive information about a change in the destination and information about a change in the estimated time of arrival in real time from the electric vehicle 10, may receive a change in the charging station power supply situation in real time from the power grid management server 300, and may receive traffic information, road change information, and the like from a traffic information center (not shown) or the like.

Thus, the charging station management server 200 may reselect an optimal charging station based on the information about the change in the destination and the information about the change in the estimated time of arrival, which are received from the electric vehicle 10, and the change in the charging station power supply situation and may change the reservation to the reselected charging station or cancel the reservation.

In S209, when arriving at the reserved charging station, the electric vehicle 10 may quickly perform charging based on the advance reservation information and the certificate. In this case, the advance reservation information may include one of the amount of charging, a billing payment means, a charging station arrival time, or a certificate.

Meanwhile, in S210, the charging station management server 200 may collect information about a current situation of charging station reservation for each charging station. In S211, the charging station management server 200 may share information about a current situation of charging station reservation of charging stations with the power grid management server 300. In FIGS. 4A and 4B, an embodiment of the present disclosure is exemplified as, but not limited to, only charging station A. In various embodiments of the present disclosure, the charging station management server 200 may collect information about a current situation of charging station reservation from a plurality of charging stations.

Thus, in S212, the power grid management server 300 may predict an amount of power demand for each charging station, an amount of power demand for each area, and an amount of power demand for each time zone based on the information about the current situation of charging station reservation.

In S213, the power grid management server 300 may determine a power supply plan and a power fee based on the predicted amount of power demand.

In S214, the power grid management server 300 may share information about the power supply plan and the power fee with charging station A and the charging station management server 200.

In S215, a charging station terminal of charging station A may identify an amount of suppliable power depending on the information about the power supply plan and the power fee and may determine electric vehicle capacity and a charging fee of charging station A. In S216, the charging station terminal of charging station A may share the electric vehicle capacity and the charging fee with the charging station management server 200.

Thus, the charging station management server 200 may change or cancel the reservation of a previously reserved case depending on a change in the electric vehicle capacity and the charging fee, which are shared.

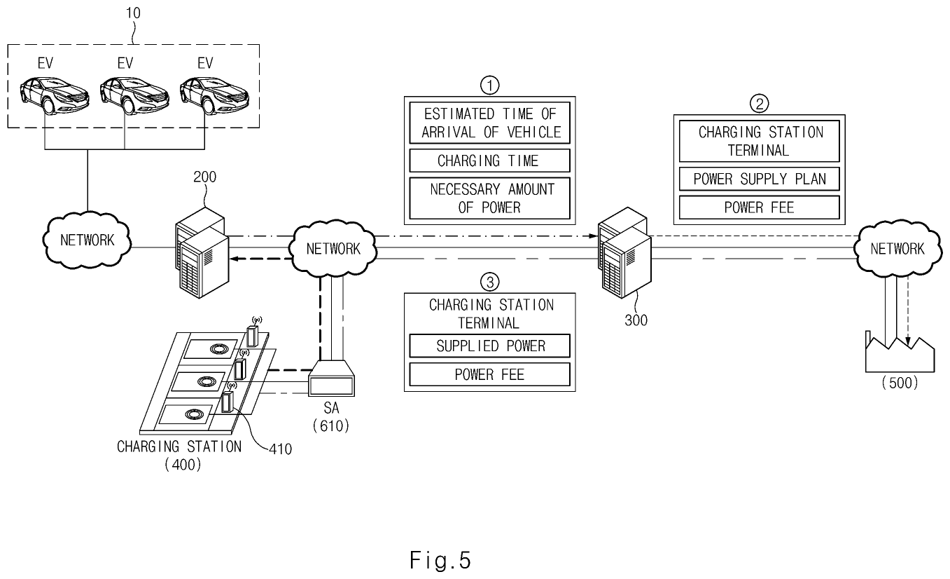

FIG. 5 is a drawing illustrating a process for reserving a charging station in an electric vehicle according to an embodiment of the present disclosure.

Referring to FIG. 5, a charging station management server 200 may provide a power grid management server 300 with information about a current situation of a charging station (e.g., an estimated time of arrival of the vehicle, a charging time, or a necessary amount of power). The power grid management server 300 may provide a power plant 500 with information about a power supply plan and a power fee for each charging station terminal and may provide a charging station terminal 410 with a power supply plan and a power fee for each charging station terminal. Thus, the charging station terminal 410 may determine vehicle capacity and a fee and may provide the charging station management server 200 with the vehicle capacity and the fee.

As such, when a power of the electric vehicle 10 for driving to a destination is insufficient, the electric vehicle 10 according to an embodiment of the present disclosure may automatically request the charging station management server 200 to reserve a charging station. The charging station management server 200 may share information in real time with the power grid management server 300 to predict an amount of power demand in real time and determine a power supply plan and a power fee.

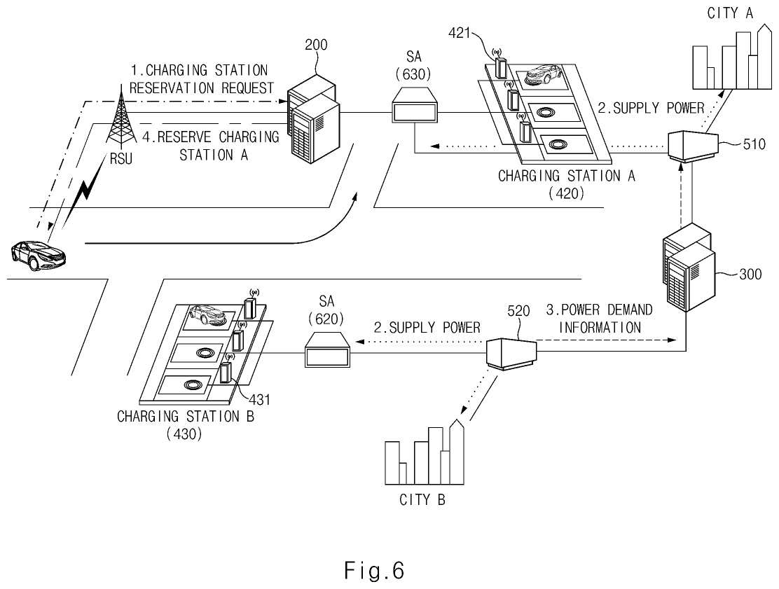

FIG. 6 is a drawing illustrating a charging reservation process according to an amount of power demand according to an embodiment of the present disclosure.

Referring to FIG. 6, a power grid management server 300 may be connected with power providers 510 and 520 and the power providers 510 and 520 may supply power to cities and charging stations.

The power provider 510 may supply power to city A and charging station A 420, and the power provider 520 may supply power to city B and charging station B 430. In this case, charging station terminals 421 and 431 of the charging stations 420 and 430 may access the power providers 510 and 520 and a charging station management server 200 via gateways 620 and 630.

The power providers 510 and 520 may provide the power grid management server 300 with power demand information of each of cities and charging stations.

In FIG. 6, when power demand of city A and charging station A 420 is low and when power demand of city B and charging station B 430 is high, and when an electric vehicle 10 requests the charging station management server 200 to reserve a charging station, the charging station management server 200 may reserve charging station A 420 with low power demand and may notify the electric vehicle 10 of the reservation.

As such, the charging station management server 200 may communicate with the power provider 510 in real time to previously obtain information about the charging station with low power demand and may mediate in reserving the charging station with the low power demand when receive a reservation request from the electric vehicle 10.

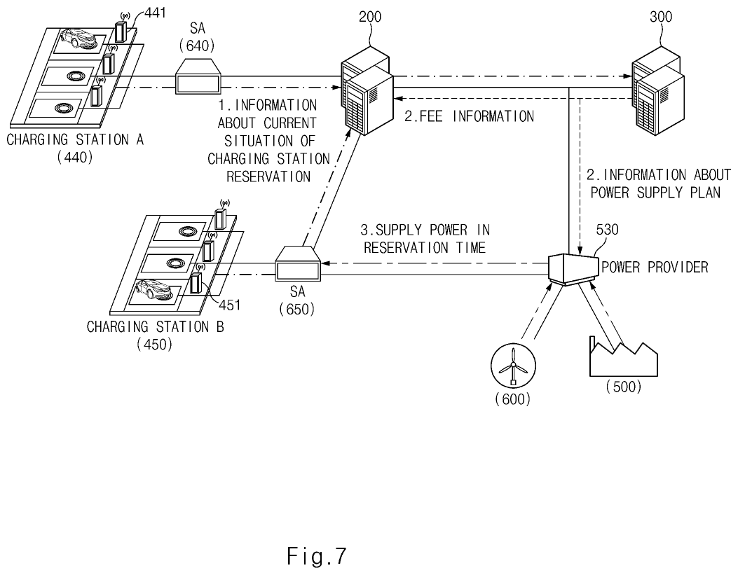

FIG. 7 is a drawing illustrating charging station reservation flow for each reservation time according to an embodiment of the present disclosure.

Referring to FIG. 7, a charging station management server 200 may receive information about a current situation of charging station reservation from each of charging stations 440 and 450, may update information about a current situation of reservation for each charging station, and may transmit the information about the current situation of reservation for each charging station to a power grid management server 300. In this case, charging station terminals 441 and 451 of the charging stations 440 and 450 may access the power provider 530 and the charging station management server 200 via gateways 640 and 650. In this case, the information about the current situation of charging station reservation is Table 2 below.

The information about the current situation of charging station reservation such as Table 2 above may include a current situation of reservation for each charging station terminal, a requested amount of charging, or fee information.

Thus, the power grid management server 300 may predict the amount of power demand for each charging station, each area, or each time zone based on the information about the current situation of charging station reservation and may determine a power supply plan and a power fee based on the amount of power demand.

For example, when three vehicles are reserved for charging at charging station A, the amount of power demand of charging station A may be predicted according to the charging request amount of each of the 3 vehicles. In addition, when 3 vehicles are reserved for charging at A charging station and 4 vehicles are reserved for charging at B charging station, and the charging time is 2 o'clock to 3 o'clock, the amount of power demand of 2 o'clock to 3 o'clock can be predicted depending on the charging request amount of a total of 7 vehicles.

The power grid management server 300 may provide a power provider 530 with information about the power supply plan and may provide the charging station management server 200 with information about the power fee.

Thus, the power provider 530 may supply power supplied from a power plant 500 or a wind turbine 600 to a corresponding charging station at a charging reservation time.

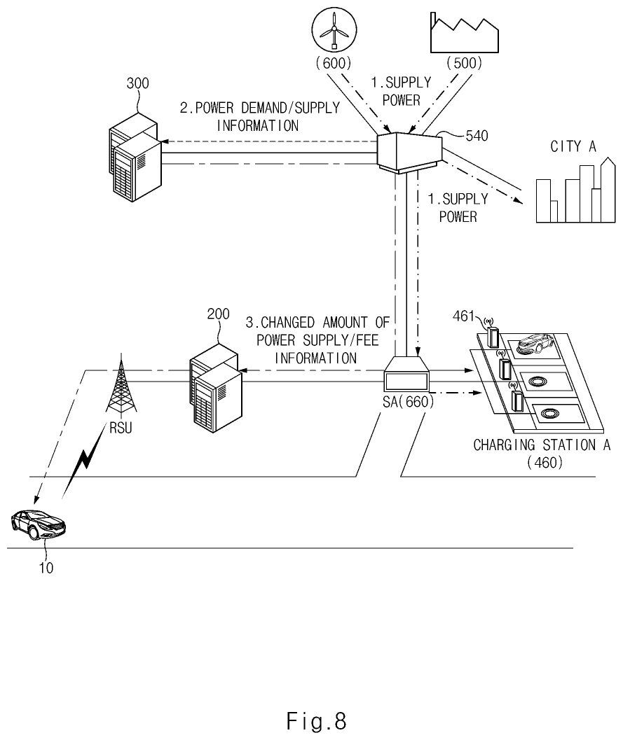

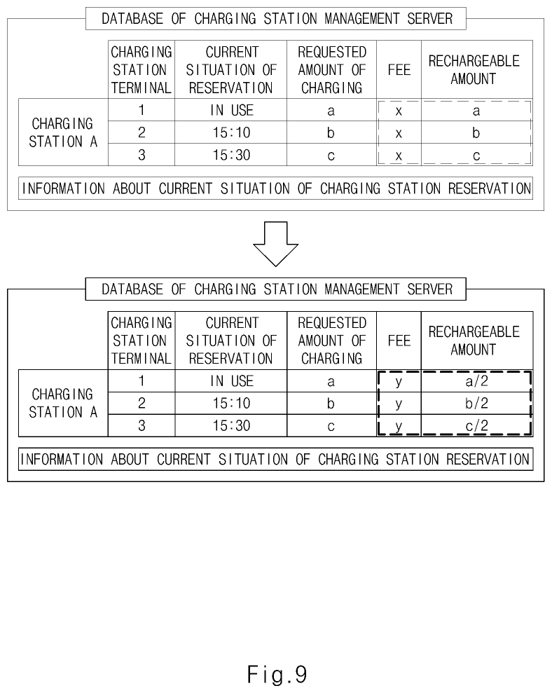

FIG. 8 is a drawing illustrating charging station management flow according to a change in the amount of power supply according to an embodiment of the present disclosure. FIG. 9 is a drawing illustrating an example of a change in information about a current situation of charging station reservation according to an embodiment of the present disclosure.

Referring to FIG. 8, a power provider 540 may receive power from a power plant 500 or a wind turbine 600 and may supply power to a charging station 460 and city A.

Furthermore, the power provider 540 may transmit power demand information and power supply information to a power grid management server 300.

When the amount of power supply of the charging station 460 is reduced and when the amount of power demand is increased, the power grid management server 300 may change a rechargeable amount and a fee for the charging station 460 as shown in FIG. 9. Referring to FIG. 9, it may be seen that a fee and a rechargeable amount for each charging station terminal of the charging station 460 are changed.

The power grid management server 300 may provide information about the changed amount of power supply and the changed fee to a charging station terminal 461 via a power provider 540. The charging station terminal 461 may provide a charging station management server 200 with the information about the changed amount of power supply and the changed fee.

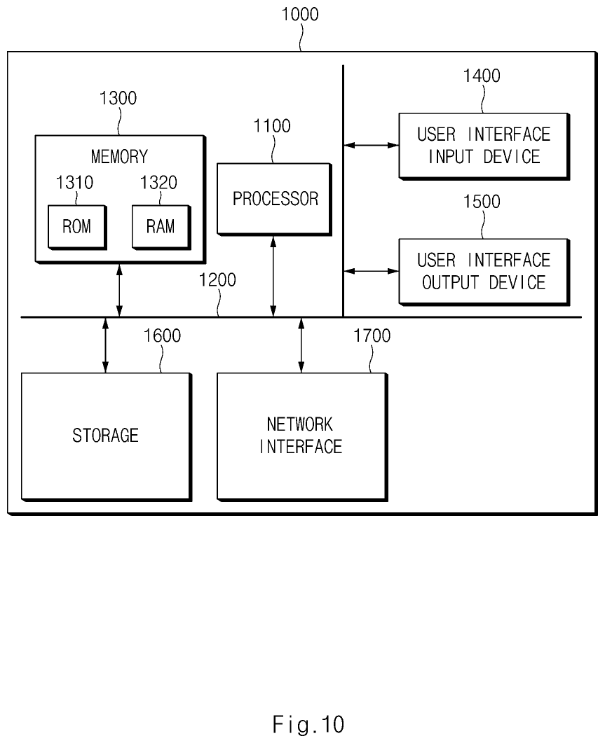

FIG. 10 is a block diagram illustrating a computing system according to an embodiment of the present disclosure.

Referring to FIG. 10, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may allow an electric vehicle to reserve a charging station without consciousness of a driver of the electric vehicle to ensure operational continuity of the electric vehicle and may change and cancel the reservation of the charging station with regard to a power supply situation of the charging station as well as a driving situation (e.g., a change in the destination, a change in the estimated time of arrival, or the like).

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. A charging station management server, comprising:
a communication device configured to communicate with an electric vehicle and a power grid management server; and
a processor configured to reserve a charging station based on driving information and information about the charging station, the driving information and the information about the charging station being received from the electric vehicle; and
wherein the processor is further configured to reserve the charging station based on information about a power supply state, the information about the power supply state being received from the power grid management server when receiving a request to reserve the charging station from the electric vehicle.

2. The charging station management server of claim 1, wherein the driving information includes at least one of a destination, a vehicle path, a battery state, a charging type, an estimated time of arrival of the vehicle, or a necessary amount of power.

3. The charging station management server of claim 1, wherein the information about the charging station includes one of a location of the charging station, information about a current situation of charging station reservation, a supported charging type, or a charging time.

4. The charging station management server of claim 3, wherein the information about the current situation of charging station reservation includes at least one of an estimated time of arrival of each of vehicles reserved for each charging station, a charging time of each of the vehicles, or a necessary amount of power of each of the vehicles.

5. The charging station management server of claim 1, wherein the processor automatically changes or cancels the reservation of the charging station depending on one of a destination, a road environment, traffic volume, a vehicle path, a battery state, an estimated time of arrival, a charging type, information about the charging station, fee information, or a payment type.

6. The charging station management server of claim 1, wherein the processor issues a certificate when the reservation of the charging station is completed.

7. The charging station management server of claim 6, wherein the processor receives advance reservation information from the electric vehicle and transmits the advance reservation information to the reserved charging station when the reservation of the charging station is completed.

8. The charging station management server of claim 1, wherein the processor reserves a charging station, the amount of power demand of which is low, depending on the amount of power demand for each charging station predicted by the power grid management server.

9. The charging station management server of claim 1, wherein the processor reserves the charging station using vehicle capacity and a charging fee for each charging station, the vehicle capacity and the charging fee being determined according to the power supply state.

10. A method for reserving a charging station, the method comprising:
receiving, at a charging station management server, a request to reserve a charging station from an electric vehicle; and
reserving the charging station based on driving information of the electric vehicle, information about the charging station, and information about a power supply state.

11. The method of claim 10, further comprising:
periodically collecting information about the charging station from the charging station and the information about the power supply state from a power grid management server.

12. The method of claim 10, wherein the reserving of the charging station includes:
selecting a charging station terminal based on the driving information, the information about the charging station, and the information about the power supply state when the driving information is received from the electric vehicle; and
providing the electric vehicle with information about the selected charging station terminal.

13. The method of claim 10, further comprising:
automatically changing or canceling the reservation of the charging station depending on one of a destination, a road environment, traffic volume, a vehicle path, a battery state, an estimated time of arrival, a charging type, information about the charging station, fee information, or a payment type.

14. The method of claim 10, further comprising:
issuing a certificate for wireless charging when the reservation of the charging station is completed.

15. The method of claim 10, further comprising:
receiving advance reservation information from the electric vehicle; and
transmitting the advance reservation information to the reserved charging station when the reservation of the charging station is completed.

16. A method for reserving a charging station, the method comprising:
predicting the amount of power demand based on information about a current situation of a charging station reservation;
determining a power supply plan and a power fee based on the predicted amount of power demand; and
providing a charging station with the power supply plan and the power fee.

17. The method of claim 15, wherein the predicting of the amount of power demand includes:
predicting at least one of the amount of power demand for each charging station, the amount of power demand for each area, or the amount of power demand for each time zone based on the information about the current situation of charging station reservation.
